(19) United States
(12) Patent Application Publication
(10) Pub. No.: US 2008/0289898 A1
(43) Pub. Date: Nov. 27, 2008

(54) Braced sound barrier vacuum panel

(76) Inventor: Michael John Rickards, Penzance (GB)

Correspondence Address: M. J. Rickards, 4 Castle Drive, Praa Sands, PENZANCE, TR20 9TF, GB

(21) Appl. No.: 12/214,861

(22) Filed: Jun. 24, 2008

(30) Foreign Application Priority Data
Jan. 26, 2007 (GB) GB0801184.3

(51) Int. Cl. G10K 11/16

(52) U.S. Cl. 181/141

(57) ABSTRACT

A vacuum panel using internal or external bracing strips to provide a substantially flat sound barrier capable of very high sound rejection independent of frequency.

### CROSS-REFERENCE TO RELATED APPLICATIONS

The invention described herein is the subject of United Kingdom Patent Application GB0801184.3, 01-26-2007. The following patents are relevant to this

Invention: DE202004021451 U, Mar. 24, 2004; U.S. Pat. No. 4,598,520; Dec. 7, 1984; EP0431285, Oct. 16, 1990; FR2261993, Feb. 21, 1974; GB2399101, Feb. 4, 2003; GB2427627, May 22, 2006.

### STATEMENT REGARDING FEDERALLY SPONSORED RESEARCH OF DEVELOPMENT

Not Applicable

### BACKGROUND OF THE INVENTION

Vacuum insulation panels comprising upper and lower sheets separated by a peripheral wall can provide, in principle, a very effective barrier to the passage of sound and heat. The problems arise from two main sources, the considerable compression a panel is under because of atmospheric pressure and the inevitable passage of heat and sound through whatever structure is used to separate the upper and lower sheets of the panel.

The use of rigid structures inside vacuum insulating panel, VIP, such as micro porous silica or rigid polyurethane foam, to overcome the effect of atmospheric compression has met with considerable commercial success despite the resulting panels being fragile and expensive to manufacture. However, such ‘filled’ panels have a high resistance to the passage of heat and represent a major advance in thermal insulation though their sound attenuating efficiency is only moderate compared with materials specifically developed for sound dampening applications.

The inward flexing, illustrated in FIG. 1, caused by atmospheric pressure acting on the upper (1) and lower (2) sheets imposes a minimum height for the peripheral wall (3) in order to prevent the sheets from making internal contact. This minimum height in turn requires a sufficient thickness of wall so that it is strong enough to withstand the compression on the panel and yet thin enough to minimize the transmission of sound and heat.

The height of the peripheral wall can be reduced by doming the upper and lower sheets, by inserting internal supports or by making the peripheral wall composite with an upper thick, a middle thin and a lower thick portion. The thickness of the peripheral wall can also be reduced by inserting narrow rods to take the compression load thus reducing the purpose of the peripheral wall to do no more than enable the vacuum seal.

### BRIEF SUMMARY OF THE INVENTION

According to the present invention the inward flexing of the upper and lower sheets is largely prevented by the use of bracing strips placed outside the vacuum panel, FIGS. 2a and 2b, or inside, FIGS. 3a and 3b or outside on one sheet and inside on the other. The internal bracing strips may also be interlaced, FIGS. 4a, 4 and 4c. In all these designs the upper and lower sheets remain substantially flat thus avoiding the inward flexing of the upper (1) and lower (2) sheets shown in FIG. 1 and so making a much narrower and consequently thinner peripheral wall possible. The rejection of sound by the panel is controlled principally by the thickness of the peripheral wall according to the empirical equation:

$$Rejection level ( dB ) = 20 log [ \frac{Upper sheet area}{Perimeter wall cross sectional area} ]$$

It is important to realise that the sound is not attenuated by the vacuum panel. The sound wave arriving at the upper sheet, for example, finds nowhere to go and is reflected back towards the source. Because the fraction of transmitted sound, through the thin peripheral wall and the residual air in the panel, is so very small the sound rejection level is substantially independent of its frequency. This unique property of vacuum panels is something new in the field of acoustics and made all the more remarkable by the fact that the panels can be made from readily available, inexpensive materials and the design is well suited to automated production.

The principal advantages of braced vacuum panels are:
1. They achieve a very high level of sound rejection maintained over a wide range of frequencies from 100 Hz to over 3000 Hz and they provide excellent thermal insulation.
2. They are robust in use and have flat surfaces, easily fixed to battens and masonry, they are light in weight and capable of maintaining vacuum integrity over long periods of time, at least ten years.
3. They can be inexpensively mass produced, in a variety of shapes and sizes, from readily available raw materials.

### BRIEF DESCRIPTION OF THE SEVERAL VIEWS OF THE DRAWING

FIG. 1 Illustrates the inward flexing of the upper and lower sheets due to atmospheric pressure.

FIG. 2a Illustrates a vacuum panel with external strip bracing.

FIG. 2b Presents a projected view of FIG. 2a

FIG. 3a Illustrates a vacuum panel with internal strip bracing.

FIG. 3b Presents a projected view of FIG. 3a.

FIG. 4a Illustrates a vacuum panel with internal interlaced strip bracing.

FIG. 4b Illustrates the interlaced strip bracing referred to in FIG. 4a

FIG. 4c Illustrates a detail of the interlaced strip bracing shown in FIG. 4b.

### DETAILED DESCRIPTION OF THE INVENTION

The invention is described in the following examples of manufactured panels.

### Example 1

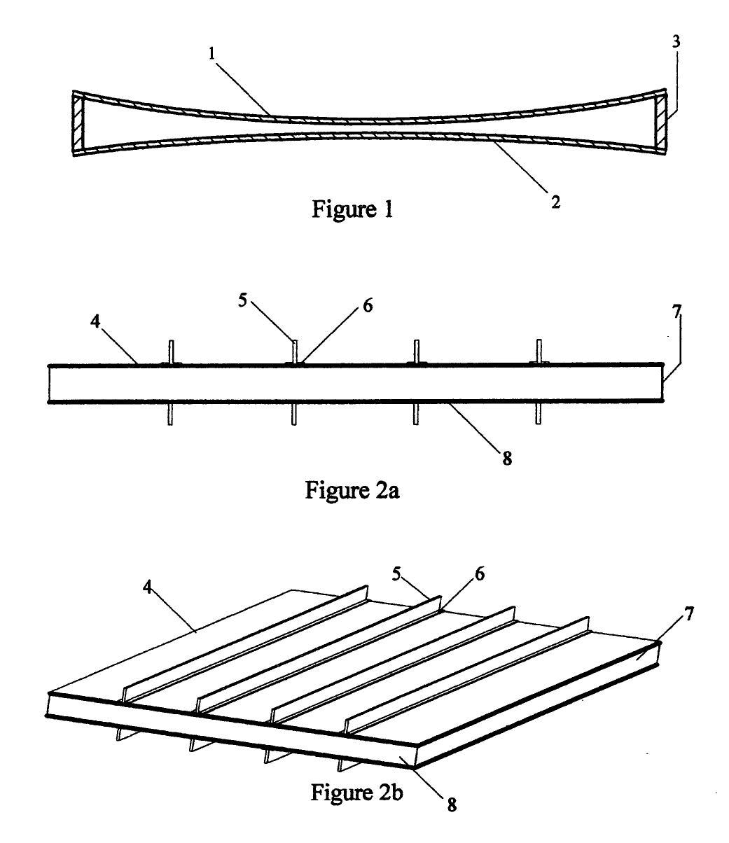

A square vacuum panel, illustrated in FIGS. 2a and 2b, with upper (4) and lower (8) sheets made from 0.8 mm thick mild steel and having 400 mm sides separated by a 15 mm high peripheral wall (7) made from 0.22 mm thick mild steel.

The upper (4) and lower (8) sheets were externally braced with four mild steel strips (5) 15 mm high and 0.8 mm thick having 5 mm wide fixing flanges (6). All components were assembled with epoxy resin and the enclosed space evacuated to less than 100 Pa. Placing the bracing strips externally to the panel brings them under compression by the action of atmospheric pressure on the panel.

This panel gave a sound rejection level in excess of 45 dB at both 100 Hz and 900 Hz.

### Example 2

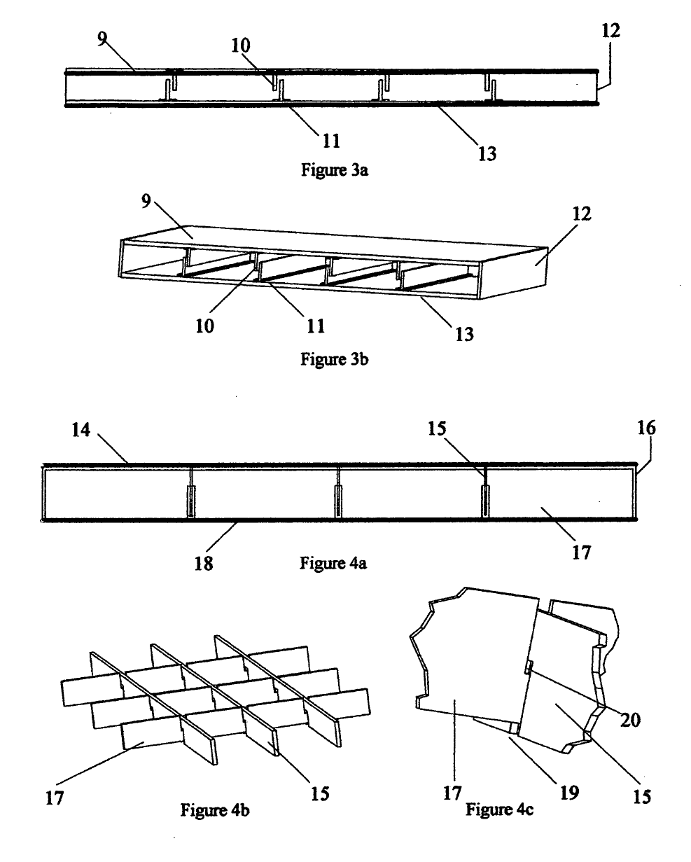

A square vacuum panel, illustrated in FIGS. 3a and 3b, with upper (9) and lower (13) sheets made from 0.8 mm thick mild steel and having 400 mm sides separated by a 20 mm high peripheral wall (12) made from 0.22 mm thick mild steel.

The sheets were internally braced with four strips (10) on each sheet the strips being 390 mm long and 15 mm high made from 0.8 mm thick mild steel with 5 mm wide fixing flanges (1). All components were assembled with epoxy resin and the enclosed space evacuated to less than 100 Pa. Placing the bracing strips inside the panel brings them under tension by the action of atmospheric pressure on the panel.

The sound rejection level for this panel was found to be more than 40 dB at 100 Hz and 900 Hz.

### Example 3

A square vacuum panel, as illustrated in FIGS. 4a, 4b and 4c, with upper (14) and lower (18) sheets made from glass fibre reinforced polyester resin 4 mm thick having a glass content of 2.4 kg m⁻². The sheets having 400 mm sides and separated by a peripheral wall (16) 20 mm high and 1.5 mm thick made from glass fibre reinforced polyester resin having a glass content of 900 g m⁻².

The upper (14) and lower (18) sheets were braced internally with three interlaced strips (15) 1.5 mm thick and 15 mm high made in a particular way as shown in FIG. 4c. The slot (19) cut into the upper strip, (15) and lower strip (17), was made 3 mm wide so as to accept the placing of the opposite strip without making contact. The height of the slot in each strip was 9 mm so as to leave a gap (20) to prevent contact between the upper (17) and lower (15) bracing strips when assembled.

As the bracing strips are mounted internally the action of atmospheric pressure on the panel brings them under tension. That stress is taken up along the uncut part of the strips.

The interlaced bracing strips were placed one at the centre of the sheet and one 100 mm on either side of the central strip. The panel was assembled and sealed with epoxy resin and the enclosed space evacuated to less than 100 Pa.

This panel gave a sound rejection level of 35 dB measured at both 100 Hz and 900 Hz.

In this document a peripheral wall is described as ‘thin’ when its height is more than five times its thickness.

Panels may be made with the bracing strips attached externally to one sheet and internally to the other thus providing a key to one side, for fixing to masonry for example, and a substantially flat surface on the other. Additionally the external bracing strips may be mounted at right angles to each other and thus provide increased stability from warping.

Though square panels are quoted in the examples given they can be triangular, trapezoidal and, to some advantage in covering large areas, hexagonal. The ability of vacuum panels to have a variety of shapes is especially useful when covering irregular areas such as the underside of a pitched roof.

What I claim as my invention is:

1. A vacuum panel comprising rectangular upper and lower sheets separated by a thin peripheral wall hermetically sealing a space evacuated to less than 100 Pa with the said sheets each braced by a single external strip centrally attached along the width of the sheets and perpendicular to them and the said strips being parallel to each other.

2. A vacuum panel as in claim 1 in which the said bracing strips are at right angles to each other.

3. A vacuum panel as in claims 1 and 2 in which both of the said bracing strips are attached internally to the said sheets.

4. A vacuum panel as in claims 1, 2 and 3 in which there are two or more bracing strips attached to each sheet.

5. A vacuum panel as in claims 1 to 4 in which the said bracing strips are attached externally to one of the said sheets and internally to the other.

6. A vacuum panel as in claim 1 in which the bracing strips are attached internally and interlace at right angles to each other.

7. A vacuum panel as in claim 6 in which two or more bracing strips are attached internally and interlace at right angles to each other.

8. A vacuum panel as in claims 1 to 8 with the upper and lower sheets shaped as a trapezium.

9. A vacuum panel as in claims 1 to 8 with the upper and lower sheets shaped as a triangle.

10. A vacuum panel as in claims 1 to 8 with the upper and lower sheets shaped as a hexagon.
